(19) United States
(12) Patent Application Publication
(10) Pub. No.: US 2025/0054340 A1
(43) Pub. Date: Feb. 13, 2025

(54) DATA LOGGING SYSTEM FOR A VEHICLE

(71) Applicant: NISSAN NORTH AMERICA, INC., Franklin, TN (US)

(72) Inventors: Gar RISAL, Bloomfield Hills, MI (US); Dion RICHTER, Ferndale, MI (US)

(21) Appl. No.: 18/447,271

(22) Filed: Aug. 9, 2023

(51) Int. Cl. G07C 5/00; G07C 5/08; H04L 12/40

(52) U.S. Cl. CPC G07C 5/008; G07C 5/085; H04L 12/40; H04L 2012/40215; H04L 2012/40273

(57) ABSTRACT

A data logging assembly for a vehicle includes a substrate, a data logger mounted on the substrate, and a power source mounted on the substrate. The data logger is configured to receive and store vehicle data. The power source is electrically connected to the data logger.

### BACKGROUND

### Technical Field

The present disclosure generally relates to a data logging system for a vehicle. More specifically, the present disclosure relates to a data logging system including a data logging assembly in which a data logger and a power source are mounted on a substrate.

### Background Information

Data logging systems are installed in vehicles to log operational data of the vehicle. The logged operational data can be accessed for analysis and/or diagnosis regarding operational performance of the vehicle.

### SUMMARY

An object of the present disclosure is to provide a vehicle data logging system including a data logging assembly in which a data logger and a power source are mounted on a substrate.

In view of the state of the known technology, one aspect of the present disclosure is to provide a data logging assembly for a vehicle. The data logging assembly includes a substrate, a data logger mounted on the substrate, and a power source mounted on the substrate. The data logger is configured to receive and store vehicle data. The power source is electrically connected to the data logger.

Another aspect of the present disclosure is to provide a vehicle data logging system including a vehicle battery, a DC-DC converter electrically connected to the vehicle battery, and a data logging assembly electrically connected to the vehicle battery and to the DC-DC converter. The data logging assembly includes a substrate, a data logger mounted on the substrate, and a power source mounted on the substrate. The data logger is configured to receive and store vehicle data. The power source is electrically connected to the data logger.

Also other objects, features, aspects and advantages of the disclosed data logging system for a vehicle will become apparent to those skilled in the art from the following detailed description, which, taken in conjunction with the annexed drawings, discloses exemplary embodiments of the data logging system for a vehicle.

### BRIEF DESCRIPTION OF THE DRAWINGS

Referring now to the attached drawings which form a part of this original disclosure:

FIG. 1 is a schematic diagram of a data logging system in accordance with an exemplary embodiment;

FIG. 2 is a schematic diagram of a peripheral control unit of the data logging system of FIG. 1;

FIG. 3 is a perspective view of a data logging assembly of the data logging system of FIG. 1;

FIG. 4 is a schematic diagram of a power system of the data logging system of FIG. 1;

FIG. 5 is an operational flowchart of the data logging system of FIG. 1; and

FIG. 6 is a schematic diagram of a network topology of the data logging system of FIG. 1.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

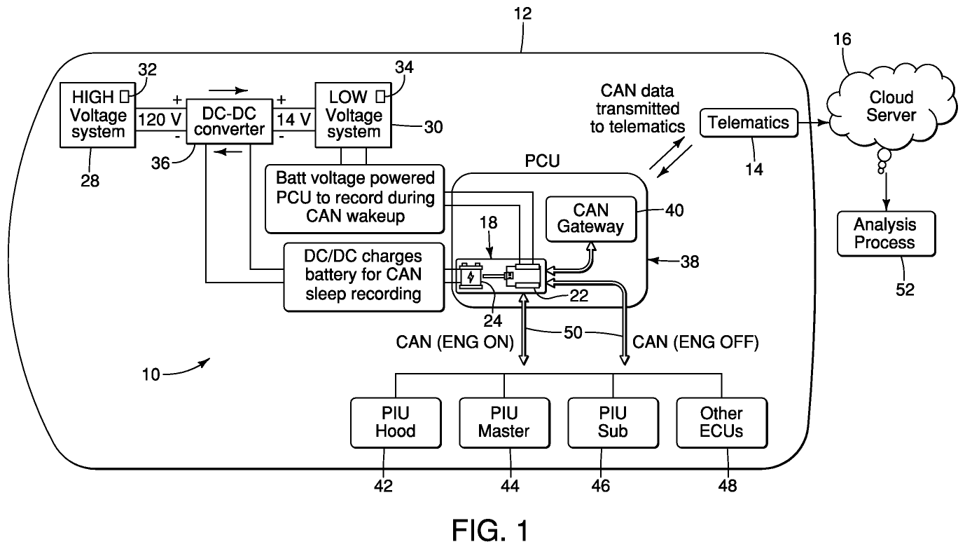

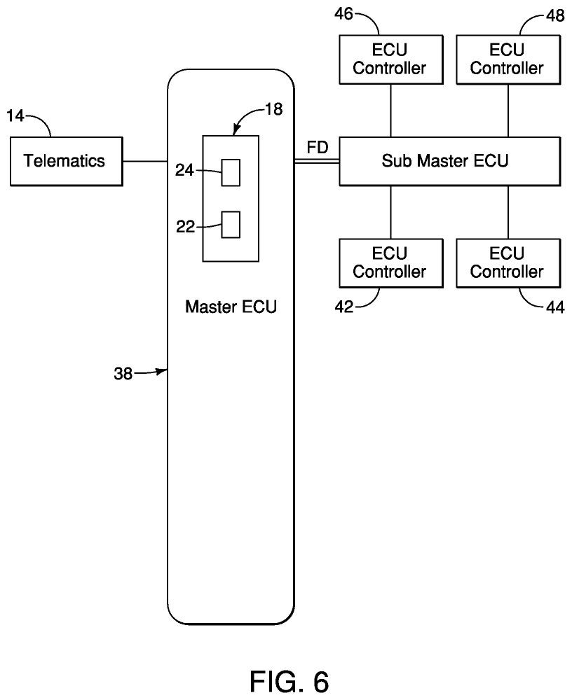

Referring initially to FIG. 1, a data logging system 10 for a vehicle 12 is illustrated in accordance with an exemplary embodiment. The data logging system 10 includes a telematics control unit (TCU) 14 configured to communicate with a remote server 16, such as a cloud server. The data logging system 10 is disposed in the vehicle 12. The vehicle 12 can be an internal combustion engine vehicle, a hybrid vehicle, or an electric vehicle. The vehicle 12 includes a controller access network (CAN) bus 50 providing CAN bus connectivity, as shown in FIGS. 1 and 6. The data logger 22 is connected to the CAN bus 50 of the vehicle 12, as shown in FIGS. 1 and 6, to receive the vehicle data.

The data logging system 10 includes a data logging assembly 18, as shown in FIGS. 1-3. The data logging assembly 18 includes a substrate 20, a data logger 22, and a power source 24.

The substrate 20 forms a printed circuit board 26 on which the data logger 22 and the power source 24 are disposed, as shown in FIG. 3. The substrate 20 can be any suitable material, such as a dielectric material, for forming the printed circuit board 26.

The data logger 22 is mounted to the substrate 20, as shown in FIG. 3, in any suitable manner, such as by welding. The data logger 22 is configured to receive and store vehicle data. The data logger 22 is any component suitable to receive and store data, such as a microcontroller. The data logger 22 is configured to be connected to the telematics control unit 14 of the vehicle 12, as shown in FIG. 1, to transmit the stored data.

The power source 24 is mounted to the substrate 20, as shown in FIG. 3, in any suitable manner, such as by welding. The power source 24 is electrically connected to the data logger 22. The power source 24 is configured to supply electrical power to the data logger 22. The power source 24 can be any suitable source of power, such as a battery. Preferably, the power source 24 is a lithium-ion battery.

The vehicle 12 includes a high voltage system 28 and a low voltage system 30, as shown in FIGS. 1 and 4. The high voltage system 28 includes a high voltage battery 32, and the low voltage system 30 includes a low voltage battery 34. The high voltage battery is preferably a 120 volt battery. The low-voltage battery 34 is preferably a 12 or 14 volt battery.

A DC-DC converter 36 is electrically connected between the high-voltage system 28 and the low-voltage system 30, as shown in FIGS. 1 and 4. The DC-DC converter 36 converts the changes the dc power from high-voltage battery 32 of the high-voltage system 28 to a lower voltage, such as 12 volts, for use by the low-voltage system 30.

As shown in FIGS. 1 and 6, the telematics control unit 14 is disposed in the vehicle 12 and is in wireless communication with the remote server 16. The telematics control unit 14 is configured to upload the logged, or stored, data from the data logger 22 to the remote server 16. The telematics control unit 14 can include, but is not limited to, a receiver, a transmitter, a transceiver, a transmitter-receiver, and contemplates any device or devices, separate or combined, capable of transmitting and/or receiving wireless communication signals. The wireless communication signals can be radio frequency (RF) signals, ultra-wide band communication signals, Bluetooth communications, cellular radio communication standard (2G, 3G, 4G LTE, 5G, etc.), and/or the like, Wi-Fi or any other type of signal suitable for short range wireless communications as understood in the vehicle field.

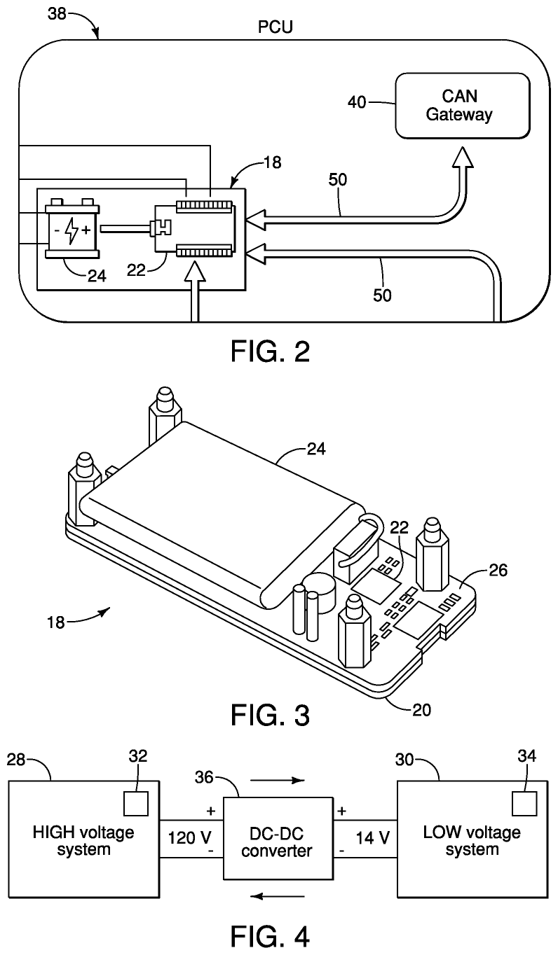

A peripheral control unit 38 includes the data logging assembly 18 and a CAN gateway 40, as shown in FIGS. 1 and 2. The peripheral control unit 38 is the primary controller, or master electronic control unit, of the vehicle 12. The CAN gateway 40 facilitates communications between the data logger 22 of the data logging assembly 18 and the telematics control unit 14. The data logging assembly 18 is preferably connected to the peripheral control unit 38 upon assembly of the vehicle 12. In other words, the data logging assembly 18 is connected to the peripheral control unit 38 prior to a first power on of the vehicle 12. Alternatively, the data logging assembly 18 can be connected to the peripheral control unit 38 subsequent to assembly of the vehicle 21. The peripheral control unit 38 is disposed at any suitable location within the vehicle 12, such as between a metal dash wall and an instrument panel skin, near a glove box, behind a shipping fuse, in a center console area, or underneath a steering wheel.

Conventional peripheral interface units (PIU), such as a PIU hood 42, PIU master 44 and a PIU sub 46, are connected to the data logger 22 of the data logging assembly 18 of the peripheral control unit 38 to transmit sensed data from a sensor to the data logger 22, as shown in FIGS. 1 and 6. Other electronic control units 48 can be connected to the data logger 22. Any sensor reading of a vehicle sensor can be transmitted to the data logger 22. Sensed data includes, but is not limited to, wheel speed, engine oil temperature, and a battery charge status. The CAN network 50, as shown in FIGS. 1 and 6, transmits data from the CAN busses, which includes CAN traffic and vehicle diagnostics, such as diagnostic trouble codes, configuration, input/output, and active test data. The data is transmitted through the CAN network 50 to the data logger 22 for storage.

The data logging assembly 18 is electrically connected to the vehicle battery, such as the low-voltage battery 34 of the low voltage system 30, and to the DC-DC converter 36, as shown in FIG. 1. The low-voltage battery 34 is electrically connected to the data logger 22 of the data logging assembly 18. The DC-DC converter 36 is electrically connected to the power source 24 of the data logging assembly 18.

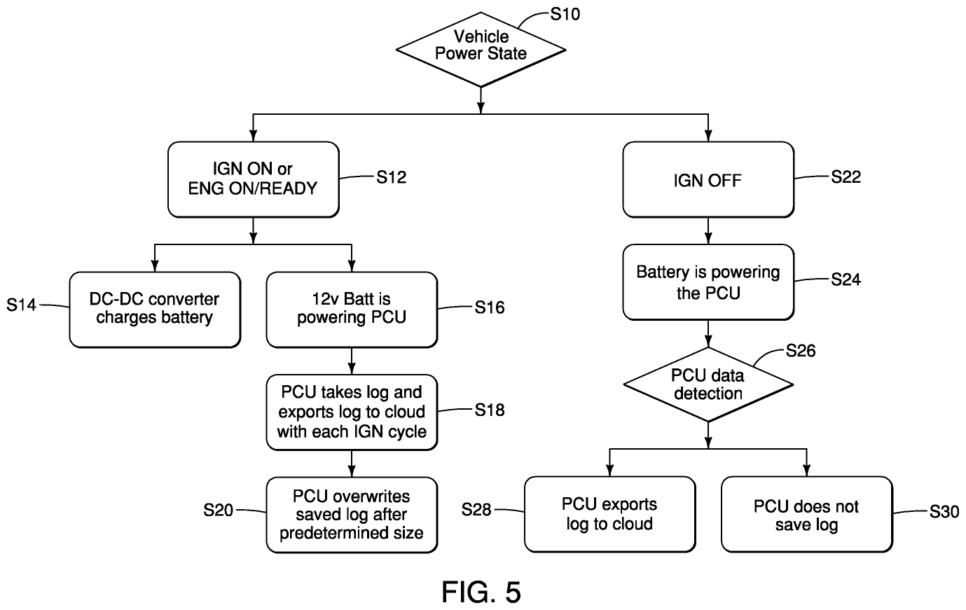

A flowchart illustrating operation of the data logging system 10 is illustrated in FIG. 5. In step S10, a vehicle power state is detected. When the vehicle is determined to be in an ignition on or engine on state, the process moves to step S12. When the vehicle is determined to be in an ignition off state, the process moves to step S22. The power states for an electric vehicle include, but are not limited to, ignition off, accessory on, ignition on and ready. The power states of an internal combustion engine vehicle include, but are not limited to, ignition off, accessory on, ignition on, and engine on. In the ignition off state, none of the electronic components of the vehicle receive power. In the accessory on power state, some electronic accessories, such as a radio, power windows and power seats, receive power. In the ignition on power state, all the electronic accessories receive power. In the ready or engine on state, the motor or engine is started to drive the vehicle. An ignition cycle includes the power state of the vehicle changing from the ignition off power state to the engine on or ready power state and back to the ignition off power state.

When the vehicle is determined to be in an ignition on or engine on power state in step S12, the DC-DC converter 36 charges the battery 24 of the data logging assembly 18 in step S14. In other words, the DC-DC converter 36 is configured to supply power to the power source 24 when the vehicle 12 is in the ignition on power state or in the engine on power state.

The low-voltage battery 34 of the low-voltage system 30 powers the peripheral control unit 38, as shown in FIG. 1 and step S18 of FIG. 5, when the vehicle 12 is determined to be in the ignition on or engine on power state. The vehicle battery, such as the low voltage battery 34, is configured to supply power to the data logger 22 when the vehicle is in the ignition on power state or in the engine on power state.

The peripheral control unit 38 gathers a log of the entire drive, which is stored by the data logger 22, during each ignition cycle. When the drive is completed, the stored drive log is transmitted from the data logger 22 through the CAN gateway 40 to the telematics control unit 14, which uploads the drive log to the remote server 16 in step S18. In other words, the data logger 22 is configured to transmit the stored data through the telematics control unit 14 after each ignition cycle of the vehicle 12. Alternatively, the data logger 22 is configured to transmit the stored data at a predetermined interval, such as every five days. A processor 52 of the remote server 16, as shown in FIG. 1, can analyze the uploaded drive log. The processor 52 can analyze the received data for pattern recognition to determine whether any issues exist regarding performance of the vehicle 12. Alternatively, a user can access the data received by the remote server 16 for analysis.

As shown in step S20 of FIG. 5, the peripheral control unit 38 overwrites the saved drive log after reaching a predetermined size or storage amount. For example, the data logger 22 can have a 100 KB capacity. The data logger 22 continues to store data logs each ignition cycle until 100 KB is reached. The data logger 22 overwrites the oldest data first after reaching the storage capacity. Alternatively, the data logger 22 is configured to overwrite the stored data after transmitting the stored data.

When the vehicle is determined to be in an ignition off power state in step S22, the process moves to step S24. The power source 24 is configured to supply power to the data logger 22 when the power state of the vehicle 12 is determined to be the ignition off power state. In the ignition off power state, the data logger 22 is configured to not receive power from the vehicle battery, such as the low-voltage battery 34 and the high-voltage battery 32, thereby preventing the data logger 22 from draining a power supply of the vehicle battery.

In step S26 of FIG. 5, the data logger 22 of the peripheral control unit 38 is configured to receive vehicle data from a sensor when the vehicle 12 is in the ignition off, or sleep, state. The data logger 22 is configured to receive any data when the vehicle is in the ignition off state, such as a wakeup signal occurring in any of the busses. For example, the flexible data rate (V-FD) bus wakes up approximately every four hours. The data logger stores the wake-up condition. In other words, the data logger is configured to receive vehicle data from a sensor, such as the flexible data rate bus, when the vehicle is in the ignition off power state. As shown in FIG. 6, the wake-up condition from the flexible data rate bus is transmitted by the PIU master, or sensor, 44.

In step S28 of FIG. 5, the data logger 22 exports the stored data through the telematics control unit 14 to the remote server 16. For example, the data logger 22 transmits the wake-up condition of the V-FD bus. When the data logger 22 does not receive any data, such as a wake-up condition, when the vehicle 12 is in the ignition off power state, the data logger 22 does not transmit any data. The data stored by the data logger 22 during the ignition off power state is transmitted to the remote server 16 at any suitable time, such as when the vehicle exits the ignition off state. The log file generated by the data logger 22 while the vehicle 12 is in the ignition off power state deletes because no data was transmitted to the data logger 22 in step S30.

As shown in FIG. 1, the data logger 22 is configured to receive sensed vehicle data when the vehicle 12 is in both the engine on/ready power state and in the engine off power state. When the vehicle 12 is in the engine on/ready power state, the data logger 22 receives power from the vehicle battery, such as the low-voltage battery 34. When the vehicle 12 is in the ignition off power state, the data logger 22 receives power from the power source 24, which is mounted on the substrate 20 with the data logger 22, such that the data logger 22 does not receive power from the vehicle battery, thereby preventing the data logger 22 from draining the power supply of the vehicle battery. The data logging assembly 18 transmits more data to the remote server that can be accessed and analyzed to more quickly resolve any issues with the vehicle 12.

The remote server 16 can transmit a request to the PCU 38 through the telematics control unit 14 to cause a diagnostics module to run a diagnostics test of the vehicle 12. The results of the diagnostics test are transmitted to and stored by the data logger 22. The data logger 22 transmits the diagnostics test results through the telematics control unit 14 to the remote server 16 for analysis. The data logging assembly 18 can be connected to the CAN network 50 in the field to further provide a flexible system for analysis of vehicle data.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of a vehicle equipped with the data logging system. Accordingly, these terms, as utilized to describe the present invention should be interpreted relative to a vehicle equipped with the data logging system.

The term “detect” as used herein to describe an operation or function carried out by a component, a section, a device or the like includes a component, a section, a device or the like that does not require physical detection, but rather includes determining, measuring, modeling, predicting or computing or the like to carry out the operation or function.

The term “configured” as used herein to describe a component, section or part of a device includes hardware and/or software that is constructed and/or programmed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A data logging assembly for a vehicle comprising:
a substrate;
a data logger mounted on the substrate, the data logger being configured to receive and store vehicle data; and
a power source mounted on the substrate, the power source being electrically connected to the data logger.

2. The data logging assembly according to claim 1, wherein
the data logger is a microcontroller.

3. The data logging assembly according to claim 1, wherein
the power source is a battery.

4. The data logging assembly according to claim 1, wherein
the data logger is configured to be electrically connected to a vehicle battery, the power source being configured to supply power to the data logger when the vehicle is in an ignition off state.

5. The data logging assembly according to claim 4, wherein
the vehicle battery is configured to supply power to the data logger when the vehicle is in an ignition on state or in an engine on state.

6. The data logging assembly according to claim 1, wherein
the data logger is configured to be connected to a telematics unit of the vehicle to transmit the stored data.

7. The data logging assembly according to claim 6, wherein
the data logger is configured to transmit the stored data at a predetermined interval.

8. The data logging assembly according to claim 7, wherein
the data logger is configured to overwrite the stored data after transmitting the stored data.

9. A vehicle data logging system, comprising:
a vehicle battery;
a DC-DC converter electrically connected to the vehicle battery; and
a data logging assembly electrically connected to the vehicle battery and to the DC-DC converter, the data logging system including
a substrate;
a data logger mounted on the substrate, the data logger being configured to receive and store vehicle data; and
a power source mounted on the substrate, the power source being electrically connected to the data logger.

10. The vehicle data logging system according to claim 9, wherein
the power source is a battery.

11. The data logging system according to claim 9, wherein
the data logger is a microcontroller.

12. The data logging system according to claim 9, wherein
the DC-DC converter is configured to supply power to the power source when the vehicle is in an ignition on state or in an engine on state.

13. The data logging system according to claim 9, wherein
the vehicle battery is configured to supply power to the data logger when the vehicle is in an ignition on state or in an engine on state.

14. The data logging system according to claim 13, wherein
the data logger is configured to not receive power from the vehicle battery when the vehicle is in an ignition off state.

15. The data logging system according to claim 9, wherein
the power source is configured to supply power to the data logger when the vehicle is in an ignition off state.

16. The data logging system according to claim 9, wherein
the data logger is connected to a telematics unit of the vehicle to transmit the stored data.

17. The data logging system according to claim 16, wherein
the data logger is configured to transmit the stored data after each ignition cycle of the vehicle.

18. The data logging system according to claim 15, wherein
the data logger is configured to receive vehicle data from a sensor when the vehicle is in the ignition off state.

19. The data logging system according to claim 18, wherein
the data logger is connected to a telematics unit of the vehicle to transmit the data received from the sensor.

20. The data logging system according to claim 16, wherein
the data logger is connected to a CAN bus of the vehicle to receive the vehicle data.
